(19) United States
(12) Patent Application Publication
(10) Pub. No.: US 2017/0343982 A1
(43) Pub. Date: Nov. 30, 2017

(54) METHOD FOR MACHINING A WORKPIECE BY MEANS OF A CHIP-REMOVING TOOL ON A NUMERICALLY-CONTROLLED MACHINE TOOL

(71) Applicant: P + L GmbH & Co. KG, Soltau (DE)

(72) Inventor: Jürgen RODERS, Soltau (DE)

(21) Appl. No.: 15/527,135

(22) PCT Filed: Jun. 30, 2015
(86) PCT No.: PCT/EP2015/064877

§ 371 Date: May 16, 2017

(30) Foreign Application Priority Data
Nov. 17, 2014 (DE) 10 2014 223 434.4

(51) Int. Cl. G05B 19/4097; B23C 5/10

(52) U.S. Cl. CPC G05B 19/4097; G05B 2219/49047; B23C 5/1009; G05B 2219/35012

(57) ABSTRACT

The invention relates to a method for machining a workpiece by means of a chip-removing tool on a numerically-controlled machine tool, in which the tool is moved relative to the workpiece along tool paths that are formed by means of a sequence of supporting points N, wherein the bounding volume that is produced during the rotation of the tool essentially comprises a point contact in a point of contact with the desired surface of the workpiece when machining the workpiece, and that in addition to the data relating to the supporting point N the data relating to the respective point of contact of the bounding volume with the desired surface of the workpiece are determined and that the tool path is optimized on the basis of the data relating to the point of contact.

### FIELD OF THE INVENTION

The invention relates to a method for machining a workpiece by means of a chip-removing tool on a numerically-controlled machine tool, in which the tool is moved relative to the workpiece along tool paths, for example lines that are formed by means of a sequence of supporting points, wherein the bounding volume that is produced during the rotation of the tool essentially comprises a point contact in a point of contact with the surface of the workpiece when machining the workpiece.

### BACKGROUND OF THE INVENTION

A milling method using spherical machining tools is frequently used to produce free-form surfaces for example in moulds for the production of synthetic material parts. There is only one point contact between the surface of the workpiece and the bounding volume that is produced by means of the rotation of the tool. In order to provide the surface of the workpiece with a specific measurement and surface quality, the tool is usually moved in lines over the workpiece that is to be produced, said lines having a small spacing between individual lines or tool paths, wherein a point contact is always maintained. The tool paths are described in a milling program by means of a sequence of supporting points that moves the machining machine from supporting point to supporting point. The closer the tool paths are programmed and the more supporting points are provided within the tool paths to describe the tool path, the more precise the machining and therefore better the surface quality will be.

The position of the individual supporting points unfortunately is not always precise even in the case of modern computer-aided manufacturing (“CAM”) systems. Within predetermined tolerances, the supporting points are sometimes too close to or too far away from the desired surface that is to be produced of the workpiece. This leads to inaccuracies and a reduction of the surface quality of the workpiece that is to be produced. Moreover, the distribution of the supporting points within the individual tool paths is frequently unfavourable. In particular, it can be that the number of supporting points in adjacent tool paths can vary considerably.

Computer numerical control (“CNC”) controllers for controlling a machining machine only have the supporting points in the milling program as information in order to interpolate the course of the tool path. If the number of supporting points in a region is considerably different or if said supporting points are not precisely calculated, depending upon the algorithms that are used, deviations for the interpolation are possible and said deviations in turn have a negative effect on the surface quality and the measuring accuracy.

In order to calculate highly accurate milling programs having many and particularly precise points, an accordingly high expenditure is required for the calculation of CAM systems. The calculation of the numerically-controlled programs takes a long time. This is undesirable and therefore it is frequently accepted that the programs are calculated with more approximate tolerances with corresponding reductions in the quality of the workpieces.

### SUMMARY OF THE INVENTION

The invention provides, in one aspect, a method for machining a workpiece using a chip-removing tool on a numerically-controlled machine tool. The method comprises forming tool paths on the workpiece with a sequence of supporting points spaced from a desired surface of the workpiece to be machined and moving the tool relative to the workpiece along tool paths, wherein a bounding volume that is produced during rotation of the tool comprises a point of contact with the desired surface of the workpiece to be machined. The method also comprises determining data relating to the point of contact of the bounding volume with the desired surface of the workpiece to be machined and optimizing the tool path on the basis of the data.

In accordance with the invention, it is consequently provided that the data relating to the supporting points, said data being provided for the movement of the tool along the tool paths, are compared with surface data relating to the workpiece that is to be produced and that, where appropriate, the position of the supporting point and thereby the movement path of the tool along the tool path is corrected. A comparison is consequently made between the constructed surface of the workpiece (the surface data) and the supporting points in the machining program. The individual supporting points of the machining program are finely corrected thereby producing a mathematically precise point of contact between the tool and the workpiece and inaccuracies of the CAM systems that calculate the tool paths are eliminated.

In accordance with the invention, the movement path of the tool that is located in the case of spherical tools parallel to the desired surface of the workpiece that is to be produced is subsequently checked as to whether the distance of the movement path that is defined by means of the individual supporting points matches precisely with the surface geometry of the workpiece that is to be produced. It is taken into account that the rotating tool forms a bounding volume by means of its cutting procedure and the point of contact of said bounding volume is set in relation to the desired surface of the workpiece that is to be produced. In accordance with the invention, a check is consequently performed as to whether the movement path that is calculated by means of a machining program, by way of example a milling program, in a CAM system comprises the correct distance over its entire length with respect to the desired surface of the workpiece that is to be produced. By means of the invention, it is possible then to correct the position of the movement path by means of the CNC controller of the machine tool.

It is particularly favourable if the data relating to the respective point of contact of the bounding volume is determined in addition to the data relating to the supporting point and the data relating to the supporting point is corrected along or parallel to a surface normal in the point of contact. The exact distance of the movement path and thereby the exact positioning of the tool is ensured by means of displacing the supporting point or by means of correcting the distance of said supporting point with respect to desired surface of the workpiece that is to be produced along a surface normal so that a precise point of contact is produced. In the case of spherical or semi spherical tools, the correction is performed along the surface normals if the supporting points describe the centre point path (centre point of the tool sphere) of the tool. If the supporting points describe the path of the tool tip or in the case of non-spherical tools, in other words for example parabolic or toric tools, in which the supporting point is not corrected along the surface normals, said correction is generally performed parallel to the surface normals since the surface normal of the point of contact does not simultaneously extend through the supporting point.

Furthermore, in accordance with the invention it can be favourable if at least one additional supporting point is added along the line or the movement path and the data relating to said supporting point are predetermined initially on a connecting line of two supporting points and are subsequently corrected with reference to the surface data in the approach in accordance with the invention.

In a similar manner, it is possible using the method in accordance with the invention to add additional tool paths that are predetermined initially with reference to tool paths, which are adjacent to supporting points, and are then corrected using the surface data.

As mentioned, it is particularly advantageous in accordance with the invention if the data relating to the original supporting points of a milling program is set by means of a CAM system while the data relating to the supporting points is corrected by means of a CNC controller of the machine tool. As a consequence, computing times in the programming system are optimised, which leads to a rapid work preparation of machining the workpiece.

The tool in accordance with the invention can comprise different forms: it can be by way of example a milling machine having a semi spherical end region, or it can comprise parabolic, toric or another tool geometry.

In accordance with the invention, it is consequently provided that the CNC controller of the machining machine in contrast to the prior art not only receives the milling program that is calculated by the CAM system as input information but rather also receives the surface data, in other words geometric information regarding the workpiece that is to be produced (three-dimensional surface data relating to the workpiece), with the aid of which the programming system has calculated the milling program. Surface data of this type can be transmitted in numerous standardised formats, for example the STEP format. With the aid of the additional information from the surface data relating to the workpiece that is to be produced, the controller can perform a check during the machining procedure for each supporting point as to whether the position of said point has been calculated to a sufficiently precise degree. For this purpose, for each supporting point of the milling program a calculation is made as to whether said supporting point lies precisely relative to the desired surface of the workpiece that is to be produced, in other words whether in fact a mathematically precise point of contact of the tool with the desired surface of the workpiece that is to be produced occurs for the position of the supporting point that is provided in the milling program or whether it is necessary to correct the supporting point in that said supporting point is slightly displaced longitudinally or parallel to a surface normal, away from the surface or towards the surface.

In addition to the above described correction along or parallel to the surface normals, it can also be particularly advantageous in accordance with the invention in addition to calculating the points of contact relating to the individual supporting points to also determine further information that is produced from the surface data relating to the workpiece that is to be produced. The information is by way of example the tangential direction of the desired surface of the workpiece at the point of contact and the resulting tangential direction of the tool path and/or the curvature of the desired surface of the workpiece in the respective point of contact. It is possible therefrom to determine the tangential direction and curvature of the tool path for the individual supporting point. In the case of spherical tools, the curvature radius of the tool path by way of example is produced for a supporting point in the case of convex surfaces by means of the addition of the radius of the desired surface of the workpiece in the tool path direction and the radius of the tool. The machining program of a CAM system calculates initially a sequence of supporting points that provide a polygonal line and thereby a polygonal tool path. By virtue of performing the correction in accordance with the invention on the basis of the point of contact that is determined in a mathematically precise manner, it is possible to adjust this polygonal path of the desired surface of the workpiece. This is performed by means of finely correcting in accordance with the invention the position of the supporting points. Simultaneously, it is possible in accordance with the invention to determine the resulting data relating to the desired surface of the workpiece in the respective point of contact. This relates in particular to the tangential direction of the path and the curvature of the path. The direction of the tool path must extend in each point of contact or in each supporting point tangentially with respect to the desired surface of the workpiece in order to correctly produce the desired surface of the workpiece. In addition to the direction of the path, it is also possible to calculate the curvature of the tool path in the respective supporting point or in the point of contact that is allocated to the supporting point. These additional values are used for the purpose of correcting the polygon of the tool path, which is initially calculated by means of the CAD/CAM program, in such a manner that the desired surface of the workpiece is produced as precisely as possible. The course of the tool path that extends through the supporting points that are corrected in accordance with the invention consequently forms in the case of spherical tools in each case an equidistant centre point path of the tool so that said centre point produces the desired surface of the workpiece as specified by the points of contact insofar as the supporting points that are output by the CAM system describe the centre point path of the tool. Supporting points are also frequently output for the tool path of a spherical tool by means of the CAM system, said supporting points describing the tool path of the tool tip, in other words the lowest point of the tool. In this case, the supporting points have however only one offset with respect to the centre point path, wherein the offset corresponds to the tool radius.

In the case of other tool geometries, by way of example toric tools, the distance between the tool centre point and the point of contact changes depending upon where the point of contact is located on the tool. Moreover, a circular contact between tool and workpiece in lieu of a point of contact can occur in the case of machining a planar surface as a special case. However, in this case, the method can also be similarly used, only that it is not the point of contact that is calculated for the individual supporting point but rather a contact surface, in this case a circle, is calculated.

Since the approximate position of the supporting points has been correctly calculated in the milling program by the CAM system, the necessary corrections of the position of the supporting points by means of the CNC controller are small and it is possible using suitable algorithms to reliably determine the correct point of contact of the tool on the desired surface of the workpiece that is to be produced for each supporting point. For this purpose, the distance of the tool to the desired surface of the workpiece is determined if the tool does not make contact with the workpiece. The distance normal with respect to the desired surface that describes the shortest distance between tool and desired surface is produced from the calculation of the distance. Subsequently, the supporting point for the tool is displaced along the distance normals in such a manner that a mathematically precise point of contact of the tool is produced insofar as this is required. If the tool is located too near to the desired surface of the workpiece the tool and the desired surface of the workpiece penetrate one another. An annular intersection line is produced that describes the intersection of tool and desired surface of the workpiece. Since the supporting points are only slightly wrong in the milling program, the diameter of the annular intersection line is particularly small. The distance normal can be found in the centre of the annular cutting line on the desired surface of the workpiece and the supporting point of the tool path is displaced in the direction of the distance normals or is displaced so far parallel to this that the tool still only makes contact with the desired surface of the workpiece in one point of contact.

This method is suitable not only for the purpose of finely correcting the position of the supporting points of a milling program as described. If the distance of the supporting points in regions or in the entire milling program is relatively large, additional supporting points can also be calculated between the supporting points that are already present in the milling program. For this purpose, one or multiple auxiliary points are initially determined on the direct connecting line between two supporting points of the milling program. These auxiliary points are then finely corrected in their position according to the above method with reference to the surface data and thus to additional highly accurate supporting points in the milling program.

According to the same principle, entire tool paths can be added into the milling program. It is already fundamentally known from DE 103 43 785 to add tool paths into milling programs. In contrast thereto, it is possible using the method in accordance with the invention to interpolate the supporting points of the added tool paths not only with reference to the already present neighbouring lines of the milling program but rather with reference to the surface data that is present to calculate their distance with respect to the desired surface of the workpiece that is to be produced.

Since the CNC controller always knows the position of the tool relative to the desired surface data during the machining procedure, said CNC controller can add additional supporting points moreover at particular sites, for example singularities such as edges or, since the geometry of forms is usually described by means of many individual partial surfaces that adjoin one another, at the transition from one partial surface to the next partial surface. Consequently, it is possible depending upon the local geometry of the desired surface of the workpiece, to add supporting points if that improves the course of the tool path in the milling program, in other words makes the course more precise. It is possible to improve the machining result not only for the position of an additional supporting point but also for determining the tangential direction or the curvature at the transitions from one part surface to the next partial surface.

Consequently, the method renders it possible for milling programs in the CAM system to calculate with relatively approximate tolerances and then nevertheless use said tolerances for highly accurate machining. An altered task distribution is consequently produced between the CAM system and CNC controller. The CAM system approximately sets the tool paths for a machining procedure with reference to a predetermined strategy and ensures that a collision does not occur in the machine when machining according to the predetermined program. The CNC controller provides the form that is to be produced for a highly accurate machining procedure with reference to the original surface data (geometry).

The invention is not limited to spherical milling tools. Parabolic, toric or other tool geometries can also be used.

### BRIEF DESCRIPTION OF THE DRAWINGS

The invention is described hereinunder with reference to an exemplary embodiment in connection with the drawing. In the drawing:

FIG. 1 illustrates a schematic view of a workpiece that is to be machined showing tool paths long which a tool is moved,

FIG. 2 illustrates a schematic view of the allocation of the movement path of the tools to the desired surface of the workpiece with corrections, and

FIG. 3 illustrates a view, similar to FIG. 2, so as to illustrate adding additional supporting points.

### DETAILED DESCRIPTION

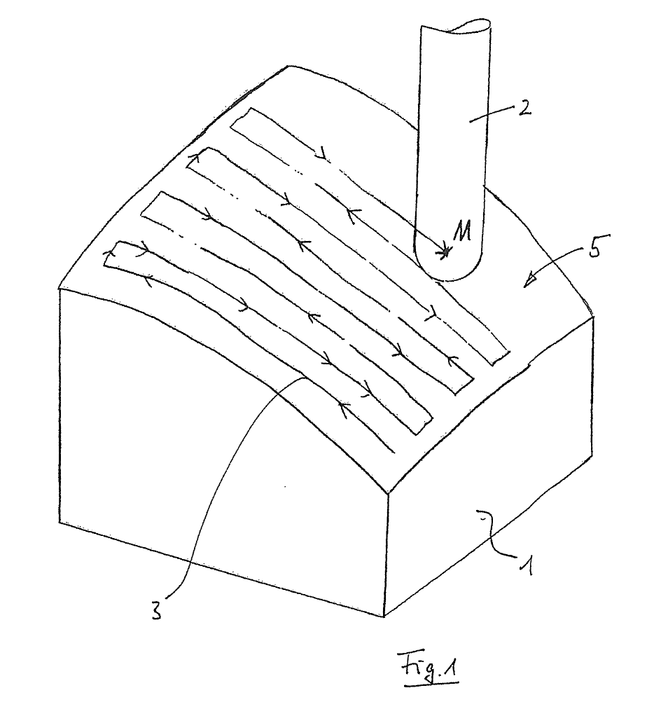

FIG. 1 illustrates the schematic view of a workpiece 1 that is machined using a spherical tool 2. The centre point path of this tool centre point M is described for the machining procedure in the machining program and said tool centre point M, as is illustrated in FIG. 1, ensures that the tool 2 moves in a line-shaped path on the surface of the workpiece 1. In the geometric data relating to the workpiece (the form), the desired surface of the workpiece 1 is contained as free-form surface data. This geometric information can be transmitted in a standard format, for example STEP, to the controller as a file. Moreover, for the machining procedure, a numerically-controlled program is transmitted to the controller and said numerically-controlled program describes the line-shaped tool path of the spherical tool 2 relative to the form by means of a sequence of supporting points.

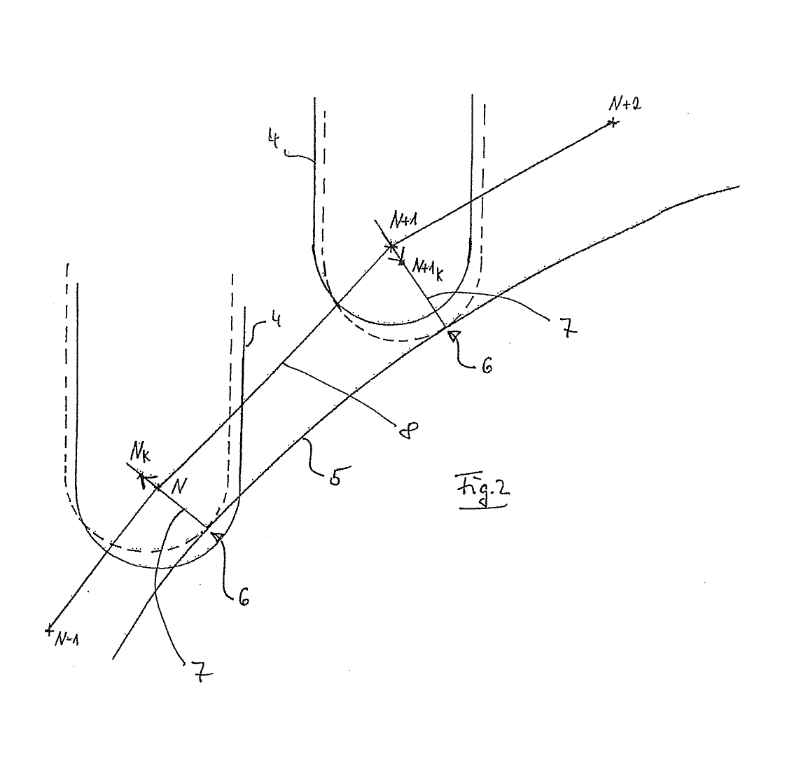

FIG. 2 is illustrated as a 2D view of a section of the tool path 3 relative to the desired surface of the workpiece 1 that is to be produced showing the supporting points of the centre point path N−1, N, N+1 and N+2. The spherical tool 2 is referred to as the bounding volume 4 for the supporting point N. It is evident that the supporting point has been calculated as too close to the desired surface of the workpiece 1 that is to be produced and when approaching the supporting point N the tool 2 would have damaged the workpiece 1, in other words would have removed too much material. With the aid of the geometric data relating to the workpiece 1 that is to be produced, it is possible to calculate the shortest distance of the supporting point N to the desired surface of the workpiece 1. The point 6 of the desired surface at which the supporting point N of the tool path 3 comprises the shortest distance is simultaneously the base point for the surface normal 7 that describes the shortest distance between the desired surface 5 of the workpiece and the supporting point N. After calculating the surface normal 7, the surface point N can be displaced along this surface normal 7, in the illustrated case away from the desired surface 5 of the workpiece 1, in such a manner until a tool 2 that is approaching the displaced, new supporting point NK makes contact with the desired surface 5 of the workpiece 1 only in the base point 6 of the surface normal 7. The position of the tool 2 for the displaced, new supporting point NK is illustrated by a dashed line. It is reversed for the supporting point N+1. The supporting point lies too far from the desired surface 5 of the workpiece 1 that is to be produced and must be moved closer to said desired surface 5 by means of the method in accordance with the invention so that the new corrected supporting point N+1k is produced for the tool 2 that is indicated by the dashed line.

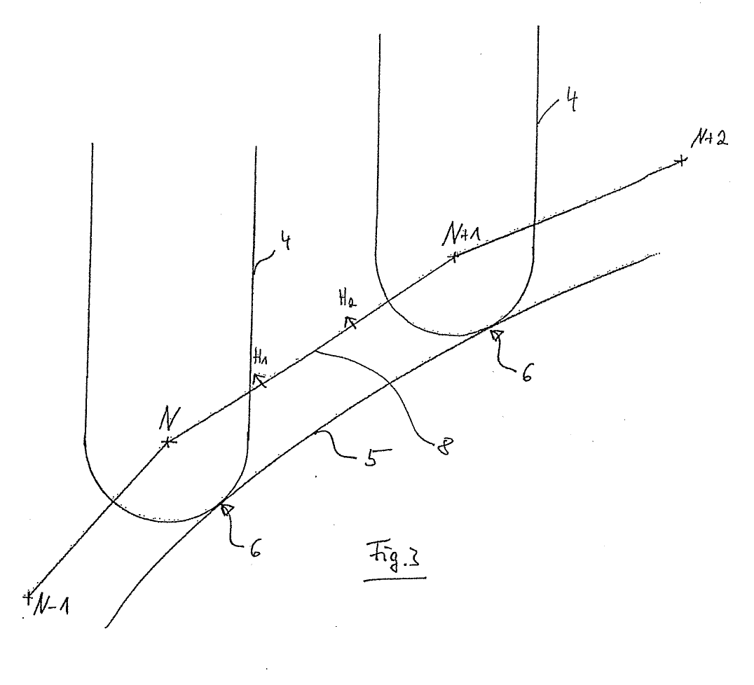

FIG. 3 likewise illustrates a 2D view of the tool path 3 for the supporting points N−1, N, N+1 and N+2. The supporting points N and N+1 are already precisely calculated so that the tool 2 that is approaching these supporting points in each case only makes contact in one point with the desired surface 5 of the workpiece 1. Since the supporting points N and N+1 are relatively far away from one another, the auxiliary points H1 and H2 are added on the connecting line 8 of the tool path 3 between N and N+1. It is clearly evident that owing to the convex desired surface 5 of the workpiece 1, the tool 2 would have been too close to the desired surface 5 of the workpiece 1 at the auxiliary points H1 and H2 and would consequently have damaged said workpiece 1. It is therefore possible with the method in accordance with the invention to correct the position of the auxiliary points H1 and H2 in such a manner that said auxiliary points become precise supporting points in the tool path 3. For this purpose, said supporting points are displaced slightly in the direction of the drawn normal vector. The machining procedure of the workpiece 1 is consequently considerably more precise.

Various features of the invention are set forth in the following claims.

1. A method for machining a workpiece using a chip-removing tool on a numerically-controlled machine tool, the method comprising:
forming tool paths on the workpiece with a sequence of supporting points spaced from a desired surface of the workpiece to be machined;
moving the tool relative to the workpiece along tool paths, wherein a bounding volume that is produced during the rotation of the tool comprises a point of contact with the desired surface of the workpiece to be machined;
determining data relating to the point of contact of the bounding volume with the desired surface of the workpiece to be machined; and
optimizing the tool path on the basis of the data.

2. The method of claim 1, further comprising correcting data relating to the supporting points along or parallel to a surface normal to the point of contact.

3. The method of claim 1, further comprising:
determining further data relating to the desired surface of the workpiece to be machined in the point of contact; and
calculating a course of the tool path for the respective supporting point.

4. The method of claim 3, wherein the further data includes one or more of: the curvature of the desired surface of the workpiece and/or of the tool path, and a tangential direction of the desired surface of the workpiece and of the tool path.

5. The method of claim 1, further comprising reading geometric surface data relating to a geometry of the workpiece to be produced from a CAD system by a CNC controller in order to calculate a correction of the supporting points.

6. The method of claim 5, further comprising:
adding at least one additional supporting point along the tool path on a connecting line of two supporting points; and
subsequently correcting the additional supporting point with reference to the geometric surface data.

7. The method of claim 5, further comprising:
adding additional tool paths that are initially predetermined with reference to supporting points of adjacent tool paths; and
correcting the supporting points of the additional tool paths using the geometric surface data.

8. The method of claim 1, further comprising correcting the data relating to the supporting points using a CNC controller of the tool machine.

9. The method of claim 1, further comprising calculating the data relating to the supporting points using a CAM system.

10. The method of claim 1, wherein the tool is a spherical tool, a parabolic tool, or a toric tool.

11. The method of claim 5, wherein the geometric surface data relating to the workpiece is in the form of free-form surface data.

12. The method of claim 2, further comprising:
determining further data relating to the desired surface of the workpiece to be machined in the point of contact; and
calculating a course of the tool path for the respective supporting point.

13. The method of claim 12, wherein the further data includes one or more of the curvature of the desired surface of the workpiece and/or of the tool path, and a tangential direction of the desired surface of the workpiece and of the tool path.

14. The method of claim 13, further comprising reading geometric surface data relating to a geometry of the workpiece to be produced from a CAD system by a CNC controller in order to calculate a correction of the supporting points.

15. The method of claim 14, further comprising:
adding at least one additional supporting point along the tool path on a connecting line of two supporting points; and
subsequently correcting the additional supporting point with reference to the geometric surface data.

16. The method of claim 15, further comprising correcting the data relating to the supporting points using a CNC controller of the tool machine.

17. The method of claim 16, further comprising calculating the data relating to the supporting points using a CAM system.

18. The method of claim 17, wherein the tool is a spherical tool, a parabolic tool, or a toric tool.

19. The method of claim 18, wherein the geometric surface data relating to the workpiece is in the form of free-form surface data.

20. A method for machining a workpiece using a chip-removing tool on a numerically-controlled machine tool, the method comprising:
forming tool paths on the workpiece with a sequence of supporting points spaced from a desired surface of the workpiece to be machined;
moving the tool relative to the workpiece along tool paths, wherein a bounding volume that is produced during the rotation of the tool comprises a point of contact with the desired surface of the workpiece to be machined;
determining data relating to the point of contact of the bounding volume with the desired surface of the workpiece to be machined;
optimizing the tool path on the basis of the data;
reading geometric surface data relating to a geometry of the workpiece to be produced from a CAD system by a CNC controller in order to calculate a correction of the supporting points;
adding at least one additional supporting point along the tool path on a connecting line of two supporting points; and
subsequently correcting the additional supporting point with reference to the geometric surface data.
